(19) United States
(12) Patent Application Publication
(10) Pub. No.: US 2009/0311476 A1
(43) Pub. Date: Dec. 17, 2009

(54) Component Unit, in particular a molded component, with a coating

(76) Inventors: Gerold Stetina, Voecklabruck (AT); Christian Sandner, Gmunden (AT); Raimund Ratzi, Weis (AT)

Correspondence Address: COLLARD & ROE, P.C., 1077 NORTHERN BOULEVARD, ROSLYN, NY, 11576, US

(21) Appl. No.: 12/083,887

(22) PCT Filed: Oct. 10, 2006
(86) PCT No.: PCT/AT2006/000412

§ 371 Date: Aug. 27, 2009

(30) Foreign Application Priority Data
Oct. 21, 2005 (AT) A 1723/2005

(51) Int. Cl. B22F 7/02; B22F 3/12; B22F 3/26; F16C 33/20; B32B 27/00; B32B 3/26; B32B 5/16; F16C 33/12

(52) U.S. Cl. 428/141; 419/5; 508/100; 428/335; 428/336; 428/320.2; 428/325; 428/327; 428/328; 428/331; 508/103; 508/106; 508/107; 508/108; 508/109

(57) ABSTRACT

The invention describes a component unit comprising at least one component (3), in particular a molded component (4), made from a powder or powder mixture containing metallic and optionally non-metallic components produced by compressing this powder or powder mixture, followed by sintering. At least one surface portion (12) of the component (3) which co-operates with another surface portion (13) of another component (14, 22) when pressure force acting between the two surface portions (12, 13) is applied is coated with an anti-friction varnish (2). The invention further relates to a method of producing such a component (3, 14, 22) with the anti-friction varnish (2).

The invention relates to a component unit comprising at least one component, in particular a molded component, made from a powder or powder mixture containing metallic and optionally non-metallic components, produced by compressing this powder or powder mixture followed by sintering, a method of producing a component made from a powder or powder mixture containing metallic and optionally non-metallic components produced by compressing this powder or powder mixture followed by sintering, as well as a method of producing co-operating surface portions of components of a component unit, at least one of which components is made from a powder or powder mixture containing metallic and optionally non-metallic components produced by compressing this powder or powder mixture, followed by sintering, and whereby the two surface portions are manufactured within pre-definable tolerance ranges with respect to one another.

A standard sintering process involves the steps of filling a compression mold with a sinterable material, pressing it to obtain what is known as a green compact, sintering this green compact at sintering temperatures, optionally followed by a baking process to impart homogeneity, as well as finishing for calibration purposes and optionally hardening.

Sintered components are used for bearing elements, amongst other things, for example in the form of metallic, self-lubricating and maintenance-free friction-type bearings. This type of bearing element includes thick-walled, sintered friction-type bearings containing solid lubricants such as graphite MoS₂, WS₂ for example, or thick-walled, sintered friction-type bearings impregnated with oil. The powder mixtures produced for the former already contain lubricants. This powder mixture is pressed and then sintered. In the case of this method, only solid lubricants which do not break down at sintering temperatures of approximately 800° C. are suitable.

The disadvantage of oil-impregnated friction-type bearings is that they contain oil and are therefore not suitable for many applications. The temperature at which bearings of this type may be used is severely limited because the oil dries out at higher temperatures.

Patent specification U.S. Pat. No. 5,217,814 discloses a friction-type bearing material which is produced by sintering Cu particles. The sintered layer is based on thicknesses of less than 1 mm and the porosities created by the sintering process occupy 35% by volume. Lubricant in the form of MoS2 and graphite is introduced into the pores. The porosity created by the sintering process is very much influenced by the particle size distribution, which means that it is often not possible to obtain the desired homogeneity.

In order to reduce friction, attempts have also been made to apply appropriate coatings to components and surfaces subjected to tribological stress. These must satisfy a whole range of requirements. Firstly, it is desirable to obtain a coating which has as low a friction as possible, which is relatively soft and which can therefore adapt well to wear-induced abrasion and the co-operating friction-type partner. On the other hand, it is necessary to impart sufficient mechanical stability and strength to enable both static and dynamic vibration stress to be absorbed, thereby increasing durability and service life.

Depending on the application, other requirements are placed on sintered molded components in addition to a bearing function. For example, surfaces which slide on one another must not generate a high noise level in order to keep environmental noise nuisance to a minimum. In the case of conventional bearing elements, this is achieved to a certain extent by providing a film of lubricating oil.

The underlying objective of this invention is to reduce the complexity involved in producing components of component units which incorporate at least one sintered molded component.

This objective is achieved by the invention due to the fact that at least one surface portion of the component, which is designed to co-operate with another surface portion of another component when a pressure force acting between the two surface portions is applied, is coated with an anti-friction varnish. The surprising advantage of the features obtained as a result of this claim resides in the fact that at least a surface portion of the sintered component can be coated with the anti-friction varnish in a single work process and the point at which it is applied already forms a pre-defined point designed to co-operate with other surface portions of another component. As a result, additional procedures for producing and assembling bearings or similar can be dispensed with, thereby saving on time and costs. Applying the anti-friction varnish also obviates the need to apply a lubricating film because the requisite lubricants are already contained in the anti-friction varnish. Depending on the lubricants and anti-friction substances selected for the anti-friction varnish, it is also possible to ensure maintenance-free force transmission between the co-operating surface portions.

As specified in claim 2, the two surface portions intended to co-operate with one another are designed so that they can be displaced in terms of their relative position. This enables friction-type bearing systems to be produced in a simple manner, without the need for extensive additional machining and additional bearing parts. The anti-friction varnish applied to these co-operating surface portions also damps noise during mutual relative movements and thus reduces the level of noise emitted by equipment and machines.

As specified in claim 3 or 4 or 5, it is of advantage if the coated surface portion has a cylindrical-shaped surface by reference to a longitudinal axis and this is used to provide a bearing point with the other surface portion, or the cylindrical surface forms a bore in the component or the cylindrical surface forms a portion of a shaft or axle. This enables friction-type bearings to be easily produced where the anti-friction varnish is applied to at least one component in order to form the bearing point. Since the coating thickness of the anti-friction varnish can be selected in advance, a seating can easily be selected whereby the components can be assembled to form the component unit once the surface portion has been coated and hardened without the need for additional finishing work. This obviates the need to produce and fit bearing parts.

As a result of the embodiment of the invention defined in claim 6 or 7, the pressure force acting between the cylindrical surfaces of the two surface portions is directed radially or the pressing force acting between the two surface portions is directed axially with respect to them, thereby pre-defining a specific force direction so that the load is transmitted uniformly between the two co-operating surface portions. This enables high pressure forces to be absorbed by the coating of anti-friction varnish, resulting in a component unit that can be produced simply and inexpensively whilst simultaneously offering a long service life.

As defined in claim 8, the coated surface portion constitutes at least tooth flanks of a gear. This results in a component which constitutes a jump in impedance with respect to transmitting structure-borne noise in the region of the contact surfaces transmitting force due to the coating of anti-friction varnish, thereby ensuring that the entire construction is damped. This enables quiet running and low-level noise of components that are moved against one another.

As result of another embodiment defined in claim 9, the other component is made from the powder or powder mixture containing metallic and optionally non-metallic components and is produced by compressing this powder or powder mixture followed by sintering. This also makes it possible to apply a coating of anti-friction varnish which adheres well in the region of the other component, thereby forming a bearing coating on both co-operating surface portions. This also enables the running properties and the quietness of the mutually moved components to be improved.

As defined in claim 10 or 11, it is of advantage if the surface portions lie against one another virtually gap-free, at least in certain regions, or if the at least virtually gap-free contact extends continuously across the mutually facing surface portions. Above all, this results in bearing points with a long service life and even high loads and pressure forces can be absorbed in the region of the co-operating surface portions without causing damage to the individual components. Quietness during running as well as the exact roundness of the contour are also improved.

Also of advantage is an embodiment defined in claim 12, whereby at least the other surface portion of the other component is coated with the anti-friction varnish, thereby enabling a resistant bearing layer to be built up in the region of the other component, which improves mutual running behavior. This also enables thinner coating thicknesses of the anti-friction varnish to be applied but in total, it is still possible to provide a sufficiently thick coating of anti-friction varnish. By means of the mutual seating in the region of the co-operating surface portions, applying a coating of anti-friction varnish to both sides will significantly improve running behavior whilst additionally damping noise emission.

As defined in claim 13 respectively 14 respectively 15, the anti-friction varnish may have a coating thickness selected from a range with a lower limit of 5 μm and an upper limit of 30 μm, or a lower limit of 10 μm and an upper limit of 20 μm, or a lower limit of 6 μm and an upper limit of 15 μm, thereby enabling the component unit to be adapted to the respective application, for example as a thrust or radial bearing, rotor or stator in VVT systems, gears, thereby resulting in durably reliable and constant properties of the component unit whilst simultaneously optimizing costs accordingly.

As defined in claim 16, the coating thickness of the anti-friction varnish has a coating accuracy with a lower limit of ±3 μm and an upper limit of ±5 μm, thereby enabling a high accuracy to be obtained in terms of the component surface but using simple production methods, namely applying an anti-friction varnish to the sintered component, thereby also enabling the gap size to be reduced, for example in the case of bearing elements or gears (tooth flank clearance).

In the case of the embodiment of the invention defined in claim 17, at least one of the components has pores in at least certain regions of the surface portion to be coated, which are filled in at least certain regions with the anti-friction varnish. In the case of the embodiments defined in claims 18 to 20, these pores may have a mean diameter selected from a range with a lower limit of 5 μm and an upper limit of 150 μm, or selected from a range with a lower limit of 10 μm and an upper limit of 100 μm, or selected from a range with a lower limit of 30 μm and an upper limit of 70 μm. This improves the adhesion of the anti-friction varnish on the sintered surface because a sort of “clawing effect” occurs, thereby enabling these component units to be exposed to a higher load.

As proposed by the invention, it is possible in principle to use any type of anti-friction varnish. However, as defined in claim 21, it is of advantage if the anti-friction varnish contains as its main element at least one thermoplastic resin because such resins are easy to process and also offer the possibility of enabling other agents or additives to be incorporated as well as fillers, thereby enabling the functions of the component unit to be varied due to an appropriate selection of these additional substances.

Accordingly, as defined in claim 22, the at least one thermoplastic resin is selected from a group comprising polyimides, in particular aromatic polyamide imides, in particular aromatic polyaryl ether imides, optionally modified with isocyanates, phenolic resins, polyaryl ether ketones, polyaryl ether-ether ketones, polyamides, for example PA 6 or PA 6.6, in particular aromatic polyoxymethylene, epoxy resins, polytetrafluoroethylene, resins containing fluorine such as polyfluoroalkoxy-polytetrafluoroethylene copolymers, ethylene-tetrafluoroethylene, fluorinated ethylene-propylene copolymers, polyvinylidene difluoride, polyethylene sulfides, polyvinyl fluoride, allylene sulfide, poly-triazo-pyromellithimides, polyester imides, polyaryl sulfides, polyvinylene sulfides, polysulfones, polyaryl sulfones, polyaryl oxides, mixtures and copolymers thereof.

For example, it is possible to use mixtures of polyimides and/or polyamide imides and/or polyaryl ether imides and/or phenolic resins and/or polyaryl ether ketones and/or polyaryl ether-ether ketones and/or polyamides and/or polyoxymethylene and/or epoxy resins and/or polytetrafluoroethylene and/or resins containing fluorine, such as polyfluoroalkoxy-polytetrafluoroethylene copolymers, and/or ethylene-tetrafluoroethylene and/or fluorinated ethylene-propylene copolymers and/or polyvinylidene difluoride and/or polyethylene sulfides and/or polyvinyl fluorides and/or allylene sulfides and/or poly-triazo-pyromellithimides and/or polyester imides and/or polyaryl sulfides and/or polyvinylene sulfides and/or polysulfones and/or polyaryl sulfones and/or polyaryl oxides with polyimides and/or polyamide imides and/or polyaryl ether imides and/or phenolic resins and/or polyaryl ether ketones and/or polyaryl ether-ether ketones and/or polyamides and/or polyoxymethylene and/or epoxy resins and/or polytetrafluoroethylene and/or resins containing fluorine, such as polyfluoroalkoxy-polytetrafluoroethylene copolymers, and/or ethylene-tetrafluoroethylene and/or fluorinated ethylene-propylene copolymers and/or polyvinylidene difluoride and/or polyethylene sulfides and/or polyvinyl fluorides and/or allylene sulfides and/or poly-triazo-pyromellithimides and/or polyester imides and/or polyaryl sulfides and/or polyvinylene sulfides and/or polysulfones and/or polyaryl sulfones and/or polyaryl oxides.

It is therefore easy to adapt to the loads to which the component unit is likely to be subjected without the need to undertake major structural changes either to the component unit or to the method used to produce the component unit.

In the case of the embodiments defined in claims 23 to 25, the proportion of resin contained in the anti-friction varnish may be selected from a range with a lower limit of 50% by weight and an upper limit of 95% by weight, or from a range with a lower limit of 60% by weight and an upper limit of 85% by weight, or from a range with a lower limit of 70% by weight and an upper limit of 75% by weight, in which case the properties of the component unit can be improved in terms of reduced friction in the case of a bearing element and/or in terms of sealing function because the gap size of sintered parts moved towards one another, determined by tolerances, can be reduced on the basis of a specific penetration of the coated surfaces to the degree that additional sealing and positioning elements can be dispensed with, and/or in terms of the damping function of force-transmitting contact surfaces due to the coating of anti-friction varnish which exhibits reduced transmission of structure-borne noise due to a jump in impedance.

Based on the embodiments of the invention defined in claim 26, the anti-friction varnish may contain at least one additive selected from a group comprising lubricants, such as MoS₂, h-BN, WS₂, graphite, WS₂, polytetrafluoroethylene, Pb, Pb-Sn-alloys, CF₂, PbF₂, hard substances such as CrO₃, Fe₃O₄, PbO, ZnO, CdO, Al₂O₃, SiC, Si₃N₄, SiO₂, Si₃N₄, clay, talc, TiO₂, mullite, CaC₂, Zn, AlN, Fe₃P, Fe₂B, Ni₂B, FeB, metal sulfides such as ZnS, Ag₂S, CuS, FeS, FeS₂, Sb₂S₃, PbS, Bi₂S₃, CdS, fibers, in particular inorganic fibers such as glass, carbon, potassium titanate, whiskers, for example SiC, metal fibers, for example of Cu or steel. Accordingly, it is also possible to use mixtures containing several additives, for example at least one lubricant and/or at least one hard substance and/or at least one fiber-type additive with at least one lubricant and/or with at least one hard substance and/or with at least one fiber-type additive. This enables friction to be reduced on the one hand and the mechanical strength of the coating of anti-friction varnish to be increased on the other hand.

Accordingly, as defined in claims 27 to 29, the proportion of additive(s) in the anti-friction varnish may be selected from a range with a lower limit of 5% by weight and an upper limit of 30% by weight, or from a range with a lower limit of 10% by weight and an upper limit of 25% by weight, or from a range with a lower limit of 15% by weight and an upper limit of 20% by weight, thereby permitting universal application of the component unit, adapted to the respective intended purpose.

As defined in claims 30 to 32, the at least one additive may have a particle size selected from a range with a lower limit of 0.5 μm and an upper limit of 20 μm, or from a range with a lower limit of 2 μm and an upper limit of 10 μm, or from a range with a lower limit of 3 μm and an upper limit of 5 μm, with a view to positively influencing the embedding behavior of the additive on the one hand and its adhesion in the resin on the other hand. Within this range of sizes, it is also possible to adapt accordingly to the behavior of the other component unit which actively sits in contact with the component unit by its surface.

Based on the embodiments defined in claims 33 or 34 or 35, the anti-friction varnish or the coating of anti-friction varnish may have a Vickers hardness selected from a range with a lower limit of 20 HV and an upper limit of 45 HV, or a lower limit of 22 HV and an upper limit of 35 HV, or a lower limit of 25 HV and an upper limit of 30 HV, thereby enabling improved anti-friction properties to be obtained whilst nevertheless assuring sufficient durability and strength of the bearing element.

The objective of the invention is also achieved independently on the basis of the embodiment defined in claim 36, whereby the proportion of polyimide resin in the anti-friction varnish, in particular the polyimide-amide resin, is selected from a range with a lower limit of 60% and an upper limit of 80%, preferably by reference to the polyimide resin dissolved in the solvent to be removed, in other words to the proportion of resin in the varnish to be applied, the proportion of MoS₂ is selected from a range with a lower limit of 15% and an upper limit of 25% and the proportion of graphite is selected from a range with a lower limit of 5% and an upper limit of 15%.

Compared with other anti-friction varnishes, this composition surprisingly exhibits an unexpected improvement in terms of the wear resistance of the component unit, in spite of the high proportion of MoS₂ and graphite in the polyimide resin. It is unexpected because with a reduced proportion of polyimide resin, which can be regarded amongst other things as a binding agent for the friction-reducing additives, one would expect the cohesion of the coating to be detrimentally affected, such that it would ultimately “crumble”. Due to the selected proportion of MoS₂ and graphite, in particular the ratio of the proportion of MoS₂ to graphite, this does not happen, although the applicant has no explanation as to why this is so at this point in time. However, it is assumed that there is an interaction between the MoS₂ and graphite particles.

In addition to improving wear resistance, an improvement in resistance to cavitation is also obtained. Moreover, a reduced susceptibility to corrosion was also observed.

It is also of advantage if the anti-friction varnish can be applied directly to the sintered metal layer, i.e. there is no longer any need for a coating to impart adhesion, thereby enabling a corresponding saving in the cost of producing the component unit.

Another advantage is the fact that this anti-friction varnish is not restricted to special component units but can currently be applied to any sintered metal as far as is currently known.

In the case of the embodiments of the invention defined in claims 37 to 39, the proportion of polyimide resin, again preferably by reference to the polyimide resin together with solvent, may be selected from a range with a lower limit of 65% and an upper limit of 75%, or a lower limit of 67.5% and an upper limit of 72.5%, or the proportion of polyamide resin may be 70%.

As defined in claims 40 to 42, it is likewise of advantage if the proportion of MoS₂ is selected from a range with a lower limit of 17% and an upper limit of 22%, or a lower limit of 18.5% and an upper limit of 21.5%, or the proportion of MoS₂ is 20%.

In the case of the embodiments defined in claims 43 to 45, the proportion of graphite may be selected from a range with a lower limit of 7% and an upper limit of 13%, or an upper limit of 8.5% and an upper limit of 11.5%, or the proportion of graphite is 10%.

In the case of all of these embodiments—as well as all the figures given below with respect to lower and upper range limits—it is possible for the respective proportions to be selected as necessary from the respective peripheral ranges between the lower limits and upper limits.

As a result of the features set out above, not only is it possible to optimize all the properties of the anti-friction varnish, it is also possible to adapt individually selected properties to the respective application, such as for example resistance to wear, resistance to corrosion, resistance to friction-induced wear, etc., even if it means that the other properties of the anti-friction varnish are not improved to the same degree.

In the case of another embodiment of the invention defined in claim 46, the ratio of MoS₂ to graphite may be selected from a range with a lower limit of 1.5:1 and an upper limit of 4.5:1.

As defined in claims 47 to 49, the MoS₂ platelets may have a mean length selected from a range with a lower limit of 10 μm and an upper limit of 40 μm, or a lower limit of 15 μm and an upper limit of 35 μm, or a lower limit of 18 μm and an upper limit of 25 μm, and/or a mean width selected from a range with a lower limit of 10 μm and an upper limit of 40 μm, or a lower limit of 15 μm and an upper limit of 35 μm, or a lower limit of 18 μm and an upper limit of 25 μm, and/or a mean height selected from a range with a lower limit of 2 nm and an upper limit of 20 nm, or a lower limit of 5 nm and an upper limit of 15 nm, or a lower limit of 5 nm and an upper limit of 8 nm.

As defined in claim 50, graphite with a grain size selected from a range with a lower limit of 2 μm and an upper limit of 8 μm may be used.

This enables the self-lubricating behavior of the anti-friction varnish to be varied over broader ranges, in which case, taking account of the respective proportions of MoS₂ and graphite, i.e. by varying the ratio of the proportions of these two additives to the polyimide resin, at least one of the properties of the polymer coating can be specifically adapted to the respective application.

During the course of testing the component unit proposed by the invention, it was also found to be of advantage if—as defined in claims 51 to 56—the surface of the anti-friction varnish has an arithmetical mean roughness value Ra based on DIN EN ISO 4287 or ASME B 46.1 selected from a range with a lower limit of 0.2 μm and an upper limit of 1.5 μm, or a lower limit of 0.5 μm and an upper limit of 1.0 lm or a lower limit of 0.8 μm and an upper limit of 0.9 μm, or if, as is the case with another embodiment, the surface of the anti-friction varnish has a maximum roughness profile height Rz based on DIN EN ISO 4287 or ASME B 46.1 selected from a range with a lower limit of 0.5 μm and an upper limit of 10 μm, or a lower limit of 3 μm and an upper limit of 8 μm, or a lower limit of 5 μm and an upper limit of 6 μm.

As a result of these features, if the component unit is designed as a bearing element, a smaller contact surface with the shaft to be supported is obtained during the running-in phase due to the profile peaks—compared with the entire internal surface of the component unit—and this results in less friction than would normally be expected on the basis of choice of material alone or a polyimide resin-steel pairing, on the one hand, and, on the other hand, after this running-in phase, these peaks may be worn to the degree that the bearing exhibits the requisite clearance tolerances.

The objective of the invention is also independently achieved by a method of producing a component as defined in claim 57, due to the fact that after sintering, an anti-friction varnish is applied to at least one surface portion of the component, in particular by spraying or painting. The advantages obtained from the combination of features defined in this claim reside in the fact that surface portions can be easily produced that are intended to co-operate with other components without the extensive finishing work usually carried out on sintered components, which can be produced inexpensively and with little complexity. Since sintered components can already be produced to a high degree of accuracy, it is usually not necessary to undertake any finishing operations even after a controlled application of the coating of anti-friction varnish, which thereby saves on costs and time compared with friction-type bearings based on a conventional design.

However, the objective of the invention may also be achieved independently on the basis of a method as defined in claim 58 for producing co-operating surface portions of components of a component unit, whereby an anti-friction varnish is applied to at least the one of the two surface portions of the component made from the powder or powder mixture in a coating thickness which corresponds to at least the gap size pre-definable by the tolerance ranges, after which the components are moved into their pre-defined relative position and the two surface portions are then moved relative to one another until the two surface portions are moved into abutting contact with one another with virtually no gap. Applying the coating of anti-friction varnish in the pre-definable coating thickness followed by the mutual relative movement results in a breaking-in phase as it were, during which the surface portions designed to co-operate with one another are aligned with one another and thus adapted to one another. Depending on the type of anti-friction varnish used, it may be that none of the coating of anti-friction varnish is removed from the region of these surface portions and instead, they are merely re-shaped or shifted, as a result of which any minimal dimensional differences which exist or lack of roundness can be compensated. Due to the fact that nothing more than a shift or re-shaping of the coating of anti-friction varnish takes place, the abrasion which usually occurs otherwise is avoided, as a result of which the gap-free design of the bearing point can be produced. If, on the other hand, a different type of anti-friction varnish is used, it is possible for at least regions of this coating of anti-friction varnish to be removed in order to obtain the mutual fit. However, any roughness peaks which exist in the base material can be re-shaped inside the anti-friction layer as well during the breaking-in phase. This results in a combination of removal of the coating of anti-friction varnish and a smoothing of the surface structure of the base material. If the coating thickness of the coating of anti-friction varnish is selected accordingly, a component unit can be adapted to the respective application, e.g. as a thrust or radial bearing, rotor or stator in VVT systems, gears, coupling parts, operating sleeves, synchronizer rings. This enables a corresponding cost optimization to be achieved whilst assuring durably reliable, constant properties of the component unit.

Another advantageous approach is defined in claim 59 or 60 or 61, whereby the virtually gap-free contact of the two surface portions with respect to one another is achieved by a displacement of elements of the anti-friction varnish effected relative to at least one surface portion, or the virtually gap-free contact of the two co-operating surface portions is obtained by removing elements of the anti-friction varnish from at least certain regions of at least one of the surface portions, or the virtually gap-free contact is established continuously across the mutually facing surface portions. To this end, elements within the coating are re-positioned due to the specific properties of the anti-friction varnish or are removed to a slight degree. Accordingly, either no material is lost due to abrasion when forming the bearing point or the material removed is shifted to other regions, thereby enabling the friction-type bearing to be produced to a high quality and with a quiet running behavior.

Another embodiment defined in claim 62 is of advantage, whereby both of the co-operating components are produced from the powder or powder mixture. This being the case, it is also possible to apply an efficiently adhering coating of anti-friction varnish in the region of the other component, thereby producing a bearing coating on both co-operating surface portions. This also enables the running properties and the quietness of the components moved on one another during running to be improved.

Finally, an approach as defined in claim 63 is of advantage, whereby both surface portions of the components are coated with the anti-friction varnish, thereby enabling a resistant bearing coating to be built up in the region of the other component as well, further improving the mutual running behavior. Accordingly, thinner coating thicknesses of the anti-friction varnish can also be applied but in total, a sufficiently thick coating of anti-friction varnish is applied. Due to the mutual fitting in the region of the co-operating surface portions, significantly improved running behavior is achieved if the coating of anti-friction varnish is applied on both sides and there is also additional damping of noise emission.

If the anti-friction varnish is to be used in conjunction with the components, in particular molded components, it is of advantage if at least one surface portion of the sintered component is coated with the anti-friction varnish in a single operation and a pre-defined point produced at the same time due to this coating, specifically intended to co-operate with other surface portions of another component. This enables additional processes for producing and assembling bearings or similar to be dispensed with, thereby saving on time and costs. Applying the anti-friction varnish also means that there is really no need to apply a lubricating film because the requisite lubricants are already contained in the anti-friction varnish. Depending on the lubricants or anti-friction substances selected for incorporation in the anti-friction varnish, it is also possible to obtain a maintenance-free transmission of force between the co-operating surface portions.

The invention will be described in more detail below with reference to examples of embodiments illustrated in the appended drawings.

They provide schematically simplified diagrams as follows:

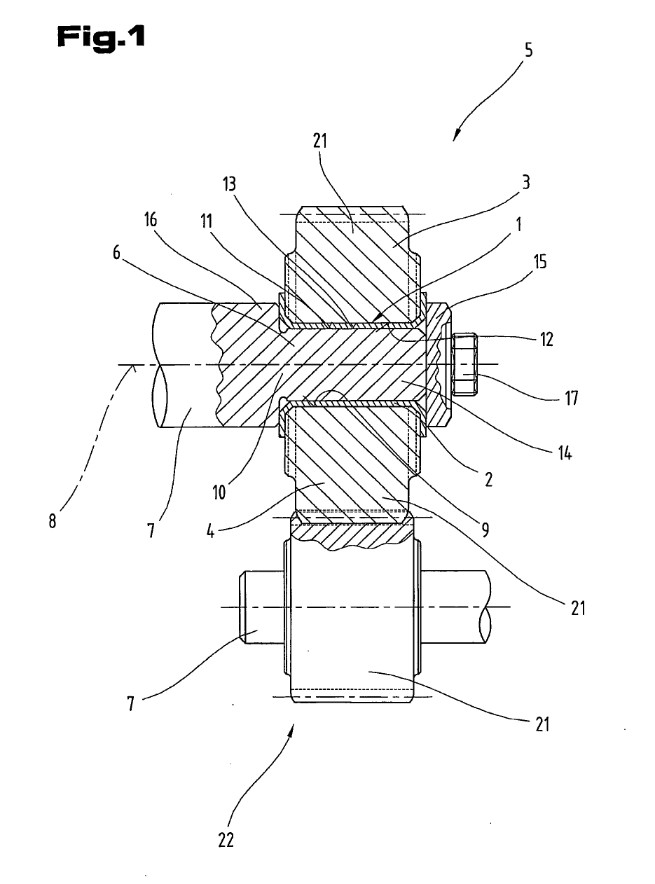

FIG. 1 is a highly simplified, schematic diagram showing a side view of a component unit comprising several components provided with at least one coating;

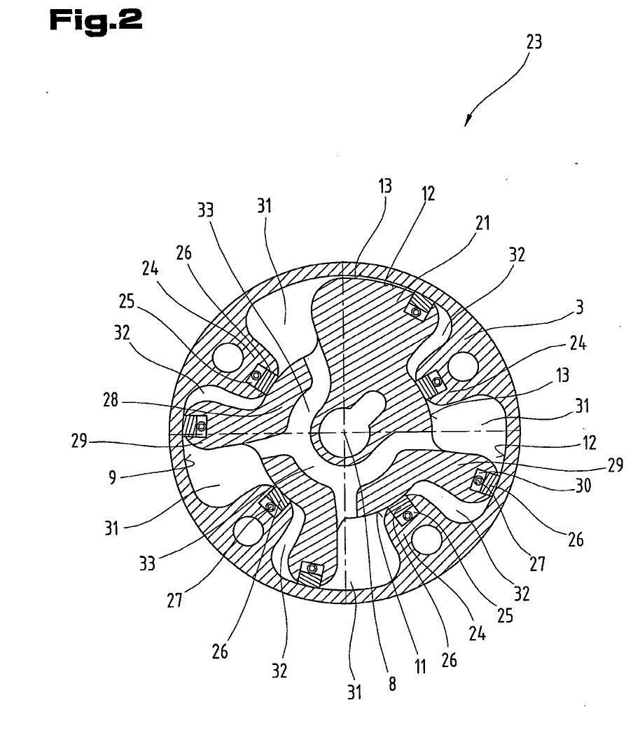

FIG. 2 is a simplified, schematic diagram showing a view in section of another component unit based on the known prior art;

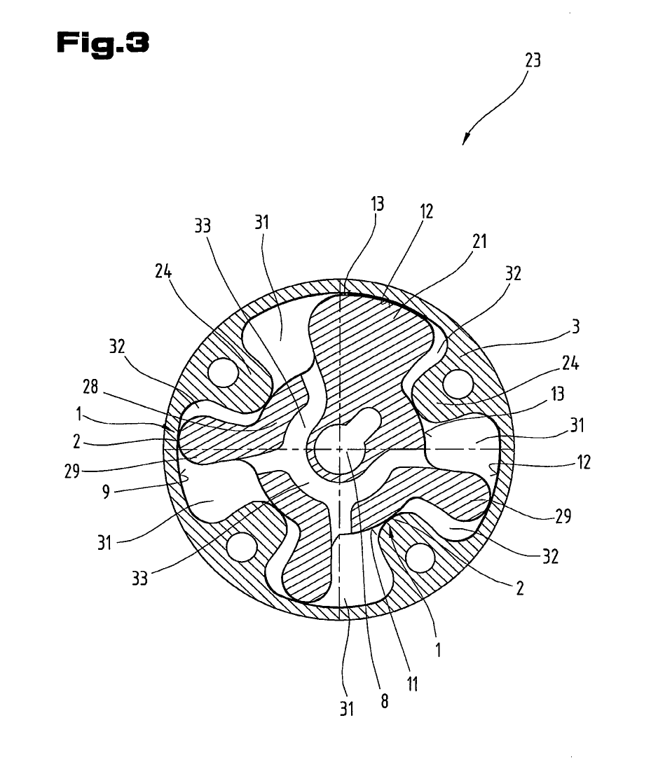

FIG. 3 is a simplified, schematic diagram showing a view in section of the component unit illustrated in FIG. 2 but provided with at least one coating in the region of co-operating surface portions;

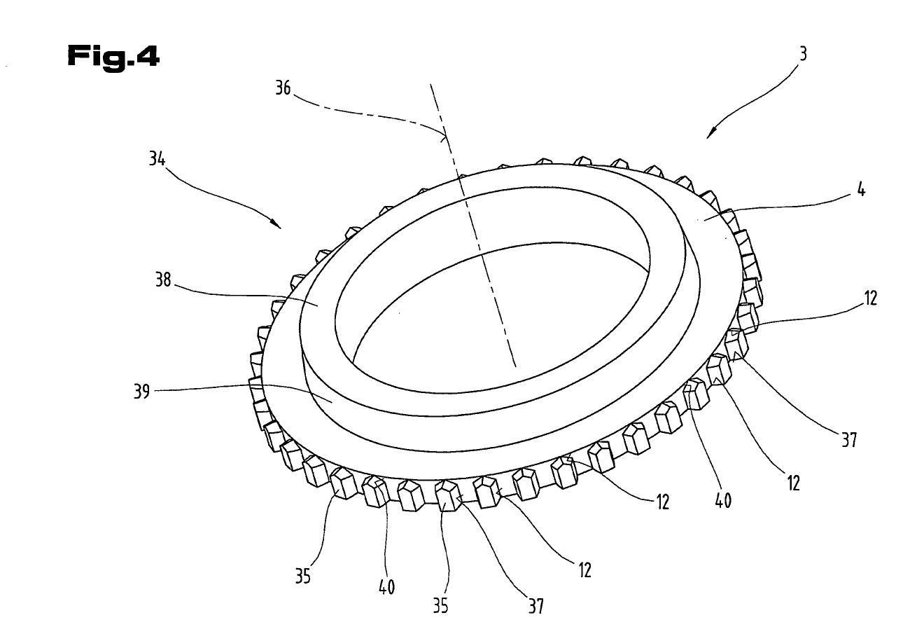

FIG. 4 is a schematically simplified diagram illustrating another component unit provided with at least one coating;

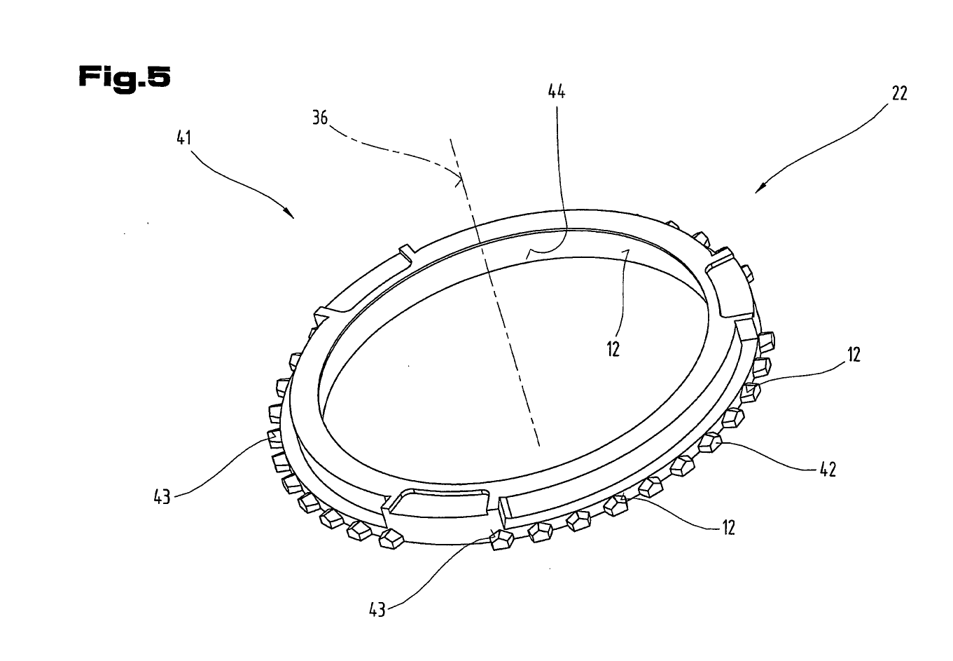

FIG. 5 is a schematically simplified diagram illustrating another component unit provided with at least one coating.

Firstly, it should be pointed out that the same parts described in the different embodiments are denoted by the same reference numbers and the same component names and the disclosures made throughout the description can be transposed in terms of meaning to same parts bearing the same reference numbers or same component names. Furthermore, the positions chosen for the purposes of the description, such as top, bottom, side, etc., relate to the drawing specifically being described and can be transposed in terms of meaning to a new position when another position is being described. Individual features or combinations of features from the different embodiments illustrated and described may be construed as independent inventive solutions or solutions proposed by the invention in their own right.

All the figures relating to ranges of values in the description should be construed as meaning that they include any and all part-ranges, in which case, for example, the range of 1 to 10 should be understood as including all part-ranges starting from the lower limit of 1 to the upper limit of 10, i.e. all part-ranges starting with a lower limit of 1 or more and ending with an upper limit of 10 or less, e.g. 1 to 1.7, or 3.2 to 8.1 or 5.5 to 10.

Firstly, it should be generally pointed out that the component units proposed by the invention and described below have a coating of an anti-friction varnish on at least their external surface. This anti-friction varnish is based on the embodiments described above and for the sake of avoiding repetition, it will not be explained specifically. The person skilled in the art may refer to the description given above.

FIG. 1 illustrates an example of an embodiment showing, by way of example, how a coating 1 in the form of an anti-friction varnish 2 is applied to at least one component 3, although the arrangement illustrated in this example is but one of many possibilities.

This component 3 is designed as a molded component 4 made from a powder or powder mixture containing metallic and optionally also non-metallic components produced by compressing this powder or powder mixture, followed by sintering. This being the case, the molded components 4 produced as the component 3 are therefore made to a very high quality in terms of dimensional accuracy, surface quality and material quality. No description will be given of how the component 3 is produced from the powder or powder mixture because this has long been known from the prior art.

This component 3 in the form of a molded component 4 in this instance might be a gear, a sprocket wheel, a chain wheel, a thrust washer, rotatably mounted parts which also effect only an oscillating movement and are subjected to an axial and/or radial load. The molded component 4 or component 3 might also be parts of couplings such as coupling bodies, parts. of claw couplings, sliding sleeves, synchronizer rings, sintered housings or similar.

In the embodiment illustrated as an example here, this component 3 is part of a gear arrangement 5 which comprises several other components. The component 3 is mounted so as to rotate on a cylindrical shoulder 6 of a shaft 7.

By reference to a longitudinal axis 8, the component 3 has an inwardly lying cylindrical surface 9. The shoulder 6 disposed in the region of the longitudinal axis 8 may also be described as a journal 10 on which another cylindrical surface 11 is formed. It is oriented concentrically with the first surface 9 of the component 3.

The surface 11 of the journal 10 serves as a bearing support for the component 3, in particular its cylindrical surface 9, to permit a turning or pivoting rotation or a movement about the longitudinal axis 8. To date, it has been standard practice to provide the bearing point using separate bearing parts, such as friction-type bearings or similar for example, which constitute the desired bearing point.

For example, the cylindrical surface 9 of the component 3 forms a first surface portion 12 in at least certain regions and the other cylindrical surface 11 of the journal 10 forms another surface portion 13 in at least certain regions. Accordingly, one of the surface portions 12 of the component 3 is designed to co-operate with at least one other surface portion 13 of another component 14, and this other component 14 may be the journal 10, for example. When the two surface portions 12, 13 are co-operating, a pressure force is transmitted between them, for example in the radial direction looking onto the longitudinal axis 8—in other words a radial force. In order to produce the bearing arrangement in the embodiment illustrated as an example here, at least the surface portion 12 of component 3 is provided with the coating 1 described above in the form of the anti-friction varnish 2, which is applied to it or joined to it in particular. The two components 3, 14 together, and optionally with other components, constitute a component unit which is a separate unit for a more complex apparatus, machine or similar.

In addition to the pressure force acting between the two surface portions 12, 13, the two surface portions 12, 13 designed to co-operate with one another may be displaceable with respect to one another in terms of their relative position. This may be achieved by any type of relative movement or displacement of the co-operating surface portions 12, 13 of the components 3, 14. Applying the anti-friction varnish 2 to at least a surface portion 12 of the component 3 already forms a bearing point with the other surface portion 13 of the component 14.

In a manner known per se, the cylindrical surface 9 of the component 3 is provided as a bore in the component 3 or molded component 4 and the other cylindrical surface 11 is a portion of a shaft or axle, such as the journal 10 for example.

The bearing arrangement of the embodiment illustrated as an example comprises at least one thrust washer 15, the purpose of which is to hold the component 3 in position in the axial direction—in other words in the direction of the longitudinal axis 8—in co-operation with a shoulder 16 projecting radially out from the journal 10. In a manner known per se, the thrust washer 15 has an orifice and has a fixing means 17 such as a screw or similar extending through it. In addition to the coating 1 in the region of the mutually facing surface portions 12, 13, it is also possible to provide such a coating 1 on the component 3 and/or the thrust washer 15 and the end face of the shoulder 16 of the other component 14 facing the component 3, as is the case with obliquely toothed gears for example. In this instance, however, the coating 1 is illustrated in these regions but only on component 3 and is so in an exaggerated coating thickness, forming a bearing point with an axial load direction—in other words for absorbing and supporting an axial force.

In order to provide better clarity, the coating thickness of the coating 1, namely the anti-friction varnish 2, is illustrated on a very much exaggerated scale to ensure that it is more visible. A coating thickness of the anti-friction varnish 2 may have a lower limit of 6 μm and an upper limit of 20 μm. Depending on the coating thickness, the coating accuracy of the anti-friction varnish 2 should be based on a lower limit of ±3 μm and an upper limit of ±5 μm. As a result, it is possible to apply the anti-friction varnish 2 within very narrow tolerances to one of the surface portions 12 and/or 13, optionally producing the bearing point already, without the need for additional work.

Since the component 3 made from the powder or powder mixture is sintered to produce a molded component 4, it has pores at least in the region of the surface portion or portions 12, 13 to be coated, although these are not illustrated. The anti-friction varnish 2 preferably penetrates the pores as it is being applied to the surface portion 12, 13 and fills at least certain regions of them. Once the anti-friction varnish 2 has hardened, this results in better surface adhesion to the coated surface portions 12, 13 because in addition to adhering to them, a positive connection is also established between the component 3, 14 to be coated, in particular its surface portions 12, 13, and the anti-friction varnish 2.

In the case of the component 3 illustrated in FIG. 1 in the form of a gear 21, it would also be possible to coat at least tooth flanks 19 of teeth 18 with the anti-friction varnish 2, in which case the coated tooth flanks 19 constitute another coated surface portion 20.

The gear 21 is formed by the component 3, in particular the molded component 4, and may operate in a drive connection with another gear, only part of which is illustrated. This other gear may in turn be provided in the form of a separate component, in particular a molded component 22, which is also made from the powder or powder mixture containing metallic and optionally non-metallic components and produced by compressing this powder or powder mixture, followed by sintering. If the gear 7 is provided in the form of a sintered molded component, at least the tooth flanks 19 of the teeth 18 may be coated within the ranges specified above. Accordingly, when meshing with other gears 7 or toothed racks, chains or similar, not illustrated, an exact and above all clearance-free engagement is established between the components transmitting the force and hence the torque. This coating 1 of anti-friction varnish 2 applied to the teeth 18, in particular the tooth flanks 19, represents a jump in impedance as regards transmitting structure-borne noise and thus damps the entire construction. As described above, the good surface adhesion of the anti-friction varnish 2 is achieved due to the intimate anchoring of the coating of anti-friction varnish in the pores close to the surface of the component 3, 14. The individual pores may also serve as a reservoir for the solid lubricant.

FIG. 2 illustrates a known design and arrangement of components 3, 21 in the form of a positioning arrangement 23, in which the outer component 3 serving as a stator has shoulders 24 distributed around the inside of its outer ring projecting out from the circumference in the direction towards the longitudinal axis 8. In each of the end regions of the shoulders 24 directed towards the longitudinal axis 8, a recess 25 is provided for accommodating at least one seal element 26 and optionally at least one positioning element 27. These components 3, 21 in turn constitute the component unit or a component group but may also belong to yet another component.

Disposed in the space enclosed by the component 3 is the other component 21, which comprises a main body 28 in the region of the longitudinal axis 8. Extending out from it are several projections 29 projecting towards the side remote from the longitudinal axis 8. These projections 29 project into the space left free between the shoulders 24 of the component 3 and extend as far as the surface portion 12 formed by several cylindrical surfaces 9.

Another recess 30 is provided on each of the terminal ends of the projections 29 facing away from the longitudinal axis 8, in which at least one seal element 26 and optionally at least one positioning element 27 is inserted or disposed. The main body 28 of the component 21 constitutes the surface portions 13 between the projections which are formed by the cylindrical portions of the surfaces 11. Due to the mutually projecting shoulders 24 and projections 29 locating radially with one another and the inserted seal elements 26, the seal elements 26 sit in a sealing contact on these surface portions 12, 13 at the mutually co-operating surface portions 12, 13.

If the component 3 is a stator and is therefore stationary relative to the other component 21, this component 21 may also be referred to as a rotor, which can be moved or pivoted about the longitudinal axis 8 within limits pre-definable by the mutually locating shoulders 24 and projections 29.

By providing the individual seal elements 26 and due to the shoulders 24 and projections 29 distributed around the circumference, chambers 21 are respectively formed between them, which are sealed off from one another by the seal elements 26 and the respective surface portions 12, 13 co-operating with them.

The fact of providing and fitting the seal elements 26 and optionally the positioning elements 27 represents additional cost in this case because of the extra components and the fact that they have to be assembled.

In the case of the embodiment illustrated as an example in FIG. 3, the positioning arrangement 23 is based on a modified design of that illustrated in FIG. 2, the same component names and reference numbers being used for the same parts as those illustrated in FIG. 2. To avoid unnecessary repetition, reference may be made to the more detailed description given in connection with FIGS. 1 and 2 above.

By contrast with the design illustrated in FIG. 2, the embodiment illustrated as an example in FIG. 3 does not have the individual seal elements 26 and positioning elements 27, and the coating 1 in the form of the anti-friction varnish 2 is applied to mutually facing and co-operating surface portions 12, 13 or at least to one of them. There is therefore no need to provide the recesses 25, 30 described in connection with FIG. 2 and the requisite seal in the region of the mutually facing and co-operating surface portions 12, 13 is provided by the coating of anti-friction varnish 2, which again penetrates the pores close to the surface of the coated surface portions 12 and/or 13.

The relative displacement between the components 3, 21 about the common axis 8 may take place by filling at least individual ones of the chambers 31 with a pressurizing medium, not illustrated, which is introduced into the bigger chambers 31 in this instance. When this pressurizing medium is introduced into the chambers 31, the component 21 is pivoted relative to the stationary component 3 about the longitudinal axis 8, as a result of which other chambers 32 on the side of the projection 29 lying opposite the first chambers 31 become smaller in volume so that the chambers 31 become larger during the pivoting movement. The chambers 31 to be filled are supplied by means of schematically illustrated lines 33 disposed in the main body 28 and connected to a pressure generator, although this is not illustrated. When the pressure is removed from the lines 33 and chambers 31, the main body 28 or component 21 is able to move so that the chambers 31 become smaller in volume and the other chambers 32 between the individual shoulders 24 and projections 29 become larger in volume. The pressurizing medium is therefore able to flow out of the chambers 31 back through the lines 33 to a supply unit or pressurizing unit, although this is not illustrated. If it is necessary to increase the volume of the chambers 32 and thus move the component 21 in the direction opposite that of the movement described above, other lines 33, not illustrated, may open into these chambers 32, thereby enabling the pressurizing medium to penetrate and drive the movement of the component 21 relative to the component 3 in the direction opposite that of the movement described above.

In order to provide an adequate seal or sealing action between the mutually co-operating and facing surface portions 12, 13, it is of advantage if this other component 21 is also made from the powder or powder mixture containing metallic and optionally also non-metallic components produced by compressing this powder or powder mixture, followed by sintering. This being the case, the surface portions 12, 13 are designed so that they lie against one another with virtually no gap, at least in certain regions. It is particularly preferable if the virtually gap-free contact is established continuously across the mutually facing and co-operating surface portions 12, 13. A particularly good sealing action is obtained if the other surface portion 13 of the other component 21 is also coated with the anti-friction varnish 2.

This virtually clearance-free or gap-free abutting contact of the two components 3, 21 at the mutually facing and co-operating surface portions 12, 13 can be achieved if at least one of the components 3, 21 is manufactured by sintering. The two surface portions 12, 13 are manufactured within the pre-definable specified tolerances or tolerance ranges with respect to one another. Since a high quality can already be achieved in terms of tolerances when manufacturing sintered components, it is not usually necessary to undertake any finishing work in specific surface regions or surface portions. The anti-friction varnish 2 is then applied to at least one of the two surface portions 12, 13 of whichever component 3, 21 is made from the powder or powder mixture to form the coating 1 in a coating thickness corresponding to at least the gap size defined by the specified tolerances or tolerance ranges. The anti-friction varnish 2 is applied when the individual components 3, 21 are still in a position or disposition separated from one another and the components 3, 21 are then moved into their pre-definable or pre-defined position relative to one another once the anti-friction varnish 2 has hardened. The two surface portions 12, 13 are then moved relative to one another until the two surface portions 12, 13 sit in contact with one another virtually gap-free,

As a result, tolerance-induced gap dimensions of sintered parts which move relative to one another can be reduced by selectively breaking in the surface portions 12, 13 coated with the anti-friction varnish 2 to the degree that additional seal or positioning elements can be dispensed with. The friction of these systems is generally reduced as a result.

In the case of the embodiment illustrated in FIG. 3, therefore, there is absolutely no need to provide the recesses 25, 30 or the seal elements 26 and the optional positioning elements 27.

Due to the virtually gap-free contact of the co-operating surface portions 12, 13 produced by the coating of anti-friction varnish 2, an efficient sealing effect is also obtained between components 3, 21 which are able to move relative to one another.

This so-called breaking-in process of the two surface portions 12, 13 described above causes these two surface portions 12, 13 to move into abutting contact with one another virtually gap-free. Due to the displacement of at least one surface portion 12, 13 relative to the surface portions 12, 13, a relative shift of elements of the anti-friction varnish 2 takes place in the coating itself. Due to the intrinsic properties of the anti-friction varnish 2, none of it is removed during the breaking-in process and instead, individual elements of it are merely shifted, thereby resulting in an exact fit of the surface geometries of the co-operating surface portions 12, 13. The components 3, 21 in turn constitute the component unit or a component group, which may also be part of yet another component.

FIG. 4 shows another component 3 in the form of a molded component 4, which is a coupling body 34 in the embodiment illustrated as an example. The same reference numbers and component names are used to denote parts that are the same as those described in connection with FIG. 1 to 3 above. Again, to avoid unnecessary repetition, reference may be made to the more detailed description given above in connection with FIGS. 1 to 3 above.

The component 3 illustrated in this instance, namely the coupling body 34, is of an approximately ring-shaped design and has projections 35 on its external circumference in the form of teeth for establishing a positive connection or coupling with another component such as an operating sleeve, although this is not illustrated. These tooth-like projections 35 have tooth flanks 37 extending more or less parallel with a longitudinal axis 36, which by reference to the projection 35 also extend towards one another at an angle to the side remote from the longitudinal axis 36. The purpose of these tooth flanks 37 or surfaces is to mesh with the coupling part, not illustrated, such as an operating sleeve, and these tooth flanks 37 each constitute the surface portions 12 which can be provided with the coating 1, namely the anti-friction varnish 2.

On its disc-shaped body bearing the projections 35, the coupling body 34 also has a tubular shoulder 38, which tapers in a conical arrangement towards the longitudinal axis 36 in the region of its external circumference. This shoulder 38 may also be termed a conical part 39. This conically extending circumferential surface of the conical part 39 or shoulder 38 also constitutes a surface portion 12 which can be provided with the coating 1, in particular the anti-friction varnish 2. However, the side faces and optionally also the internal surfaces of the shoulder 38 may also each constitute a surface portion 12 which may be provided with the coating 1.

The individual projections 35 also have roof surfaces 40 on the end facing the shoulder 38 extending in a roof-shape with respect to one another and becoming wider in the direction towards the tooth flanks 37, which are also surface portions 12 to which the coating 1 can be applied, in particular the anti-friction varnish 2.

The coating 1 is applied to the region of the roof surfaces 40 in order to improve the anti-friction properties of the operating sleeve by reducing friction, thereby guaranteeing an easier and more reliable coupling operation. The coating 1 on the tooth flanks 37 likewise improves the anti-friction properties in conjunction with the operating sleeve, thereby improving and making engagement and disengagement easier.

The coating in the region of the circumferential surface of the conical part 39 imparts a constant coefficient of friction, thereby preventing seizing with the co-operating part.

FIG. 5 illustrates another component 3 in the form of a synchronizer ring 41, the same reference numbers and component names being used to denote parts which are the same as those described in connection with FIGS. 1 to 4 above. Again, to avoid unnecessary repetition, reference may be made to the more detailed descriptions given in connection with FIGS. 1 to 4 above.

This synchronizer ring 41 is of a tubular or annular design with the longitudinal axis 36 at its center. Disposed on its external circumference are other projections 42, spaced apart from one another in the circumferential direction. These projections 42 also have roof surfaces 43 constituting surface portions 12 to which the coating 1 is applied, in particular the anti-friction varnish 2. On its internal circumference facing the longitudinal axis 36, the synchronizer ring 41 has a conical surface 44, which is likewise a surface portion 12 which is coated. In this instance, the purpose of the coating 1 on the conical surface 44 is to afford a constant coefficient of friction and thus prevent seizing with the co-operating component, such as an operating sleeve for example. The coating 1 applied to the roof surfaces 43 also improves anti-friction properties with respect to the co-operating components, in particular the operating sleeve.

The resin used for the anti-friction varnish may be placed in at least one solvent, in particular an organic solvent, such as xylene, thereby making processing easier. The proportion of solvent may be selected from a range with a lower limit of 40% by weight and an upper limit of 80% by weight, in particular with a lower limit of 50% by weight and an upper limit of 70% by weight, preferably with a lower limit of 60% by weight and an upper limit of 65% by weight, relative to the proportion of resin, i.e. resin together with solvent. The dry proportion of resin, in particular the polyamide imide resin, may be selected from a range with a lower limit of 20% by weight and an upper limit of 50% by weight, in particular a lower limit of 30% by weight and an upper limit of 40% by weight, preferably a lower limit of 35% by weight and an upper limit of 37.5% by weight. Accordingly, a polymer coating 4 applied as proposed by the invention may have a dry composition of 35% by weight of polyamide imide resin, 45% by weight of MoS₂ and 20% by weight of graphite or a dry composition calculated on the basis of the value ranges specified for the individual contents of the polymer coating 4. As may be seen from the explanation given above, all the values relating to the compositions of the anti-friction varnish are based on the “wet product”, in which case the ranges of the proportions for MoS₂ and graphite must be adapted accordingly, in other words relate to the “dry product”.

The embodiments illustrated as examples represent possible variants of the molded component or component, and it should be pointed out at this stage that the invention is not specifically limited to the variants specifically illustrated, and instead the individual variants may be used in different combinations with one another and these possible variations lie within the reach of the person skilled in this technical field given the disclosed technical teaching. Accordingly, all conceivable variants which can be obtained by combining individual details of the variants described and illustrated are possible and fall within the scope of the invention.

For the sake of good order, finally, it should be pointed out that, in order to provide a clearer understanding of the structure of the molded component or component, it and its constituent parts are illustrated to a certain extent out of scale and/or on an enlarged scale and/or on a reduced scale.

The objective underlying the independent inventive solutions may be found in the description.

Above all, the individual embodiments of the subject matter illustrated in FIGS. 1; 2; 3; 4; 5 constitute independent solutions proposed by the invention in their own right. The objectives and associated solutions proposed by the invention may be found in the detailed descriptions of these drawings.

### LIST OF REFERENCE NUMBERS

### 1 Coating

2 Anti-friction varnish

### 3 Component

4 Molded component
5 Gear arrangement

### 6 Shoulder

### 7 Shaft

8 Longitudinal axis

### 9 Surface

### 10 Journal

### 11 Surface

12 Surface portion
13 Surface portion

### 14 Component

15 Thrust washer

### 16 Shoulder

17 Fixing means

### 18 Teeth

19 Tooth flank
20 Surface portion

### 21 Gear

### 22 Component

23 Positioning arrangement

### 24 Shoulder

### 25 Recess

26 Seal element
27 Positioning element
28 Main body

### 20 Projection

### 30 Recess

### 31 Chamber

### 32 Chamber

### 33 Line

34 Coupling body

### 35 Projection

36 Longitudinal axis
37 tooth flank

### 38 Shoulder

39 Conical part
40 Roof surface
41 Synchronizer ring

### 42 Projection

43 Roof surface
44 Conical surface

1. Component unit comprising at least one component (3), in particular a molded component (4), made from a powder or powder mixture containing metallic and optionally non-metallic components and produced by compressing this powder or powder mixture, followed by sintering, wherein at least one surface portion (12) of the component (3), which is designed to co-operate with another surface portion (13) of another component (14, 22) when a pressure force acting between the two surface portions (12, 13) is applied, is coated with an anti-friction varnish (2).

2. Component unit according to claim 1, wherein the two surface portions (12, 13) designed to co-operate can be moved in terms of their position relative to one another.

3. Component unit according to claim 1, wherein the coated surface portion (12) is a cylindrical surface (9, 11) by reference to a longitudinal axis (8) and is provided as a means of affording a bearing point with the other surface portion (13).

4. Component unit according to claim 3, wherein the cylindrical surface (9) forms a bore in the component (3).

5. Component unit according to claim 3, wherein the cylindrical surface (11) forms a portion of a shaft or axle.

6. Component unit according to claim 3, wherein the pressure force acting between the cylindrical surfaces (9, 11) of the two surface portions (12, 13) is directed radially to them.

7. Component unit according to claim 1, wherein the pressure force acting between the two surface portions (12, 13) is directed axially to them.

8. Component unit according to claim 1, wherein the coated surface portion (20, 12) forms at least tooth flanks (19, 37) of a gear (21) or coupling body (34), roof surfaces (40, 43) of a projection (35, 42) of the coupling body (34) or of a synchronizer ring (41).

9. Component unit according to claim 1, wherein the other component (14, 21) is made from the powder or powder mixture containing metallic and optionally non-metallic components and is produced by compressing this powder or powder mixture, followed by sintering.

10. Component unit according to claim 1, wherein the surface portions (12, 13) lie in abutting contact virtually gap-free in at least certain regions.

11. Component unit according to claim 10, wherein the at least virtually gap-free contact extends continuously across the mutually facing surface portions (12, 13).

12. Component unit according to claim 1, wherein at least the other surface portion (13) of the other component (14, 22) is coated with the anti-friction varnish (2).

13. Component unit according to claim 1, wherein the anti-friction varnish (2) has a coating thickness with a lower limit of 5 μm and an upper limit of 30 μm.

14. Component unit according to claim 1, wherein the anti-friction varnish (2) has a coating thickness with a lower limit of 10 μm and an upper limit of 20 μm.

15. Component unit according to claim 1, wherein the anti-friction varnish (2) has a coating thickness with a lower limit of 6 μm and an upper limit of 15 μm.

16. Component unit according to claim 1, wherein the coating thickness of the anti-friction varnish (2) has a coating accuracy with a lower limit of ±3 μm and an upper limit of ±5 μm.

17. Component unit according to claim 1, wherein at least one of the components (3, 14, 22) has pores in at least certain regions of the surface portion (12, 13, 20) to be coated and the anti-friction varnish (2) fills at least some of these.

18. Component unit according to claim 17, wherein the pores have a mean diameter selected from a range with a lower limit of 5 μm and an upper limit of 150 μm.

19. Component unit according to claim 17, wherein the pores have a mean diameter selected from a range with a lower limit of 10 μm and an upper limit of 100 μm.

20. Component unit according to claim 17, wherein the pores have a mean diameter selected from a range with a lower limit of 30 μm and an upper limit of 70 μm.

21. Component unit according to claim 1, wherein the anti-friction varnish (2) contains a thermoplastic resin as the main element.

22. Component unit according to claim 21, wherein the at least one thermoplastic resin is selected from a group comprising polyimides, in particular aromatic polyamide imides, in particular aromatic polyaryl ether imides, optionally modified with isocyanates, phenolic resins, polyaryl ether-ether ketones, polyamides, in particular aromatic epoxy resins, polytetrafluoroethylene, resins containing fluorine such as polyfluoroalkoxy-polytetrafluoroethylene-copolymers, ethylene-tetrafluoroethylene, fluorinated ethylene-propylene copolymers, polyvinylidene difluoride, polyvinyl fluoride, allylene sulfide, poly-triazo-pyromellithimides, polyester imides, polyaryl sulfides, polyvinylene sulfides, polysulfones, polyaryl sulfones, polyaryl oxides, mixtures and copolymers thereof.

23. Component unit according to claim 21, wherein the proportion of resin in the anti-friction varnish (2) is selected from a range with a lower limit of 50% by weight and an upper limit of 95% by weight.

24. Component unit according to claim 21, wherein the proportion of resin in the anti-friction varnish (2) is selected from a range with a lower limit of 60% by weight and an upper limit of 85% by weight.

25. Component unit according to claim 21, wherein the proportion of resin in the anti-friction varnish (2) is selected from a range with a lower limit of 70% by weight and an upper limit of 75% by weight.

26. Component unit according to claim 21, wherein the resin contains at least one additive selected from a group comprising lubricants such as MOS₂, h-BN, WS₂, graphite, WS₂, polytetrafluoroethylene, Pb, Pb-Sn-alloys, CF₂, PbF₂, hard substances such as CrO₃, Fe₃O₄, PbO, ZnO, CdO, Al₂O₃, SiC, Si₃N₄, SiO₂, Si₃N₄, clay, talc, TiO₂, mullite, CaC₂, Zn, AlN, Fe₃P, Fe₂B, Ni₂B, FeB, metal sulfides such as ZnS, Ag₂S, CuS, FeS, FeS₂, Sb₂S₃, PbS, Bi₂S₃, CdS, fibers, in particular inorganic fibers such as glass, carbon, potassium titanate, whiskers, for example SiC, metal fibers, for example Cu or steel.

27. Component unit according to claim 26, wherein the proportion of additive(s) in the anti-friction varnish (2) is selected from a range with a lower limit of 5% by weight and an upper limit of 30% by weight.

28. Component unit according to claim 26, wherein the proportion of additive(s) in the anti-friction varnish (2) is selected from a range with a lower limit of 10% by weight and an upper limit of 25% by weight.

29. Component unit according to claim 26, wherein the proportion of additive(s) in the anti-friction varnish (2) is selected from a range with a lower limit of 15% by weight and an upper limit of 20% by weight.

30. Component unit according to claim 26, wherein the at least one additive has a particle size selected from a range with a lower limit of 0.5 μm and an upper limit of 20 μm.

31. Component unit according to claim 26, wherein the at least one additive has a particle size selected from a range with a lower limit of 2 μm and an upper limit of 10 μm.

32. Component unit according to claim 26, wherein the at least one additive has a particle size selected from a range with a lower limit of 3 μm and an upper limit of 5 μm.

33. Component unit according to claim 1, wherein the anti-friction varnish (2) has a Vickers hardness selected from a range with a lower limit of 20 HV and an upper limit of 45 HV.

34. Component unit according to claim 1, wherein the anti-friction varnish (2) has a Vickers hardness selected from a range with a lower limit of 22 HV and an upper limit of 35 HV.

35. Component unit according to claim 1, wherein the anti-friction varnish (2) has a Vickers hardness selected from a range with a lower limit of 25 HV and an upper limit of 30 HV.

36. Component unit according to claim 1, wherein the anti-friction varnish (2) contains a polyimide resin, in particular a polyamide imide resin, molybdenum disulfide (MOS₂) and graphite, and the proportion of polyimide resin is selected from a range with a lower limit of 60% and an upper limit of 80%, the proportion of MOS₂ is selected from a range with a lower limit of 15% and an upper limit of 25% and the proportion of graphite is selected from a range with a lower limit of 5% and an upper limit of 15%, and the proportion of polyimide resin is preferably based on the polyimide resin together with the solvent to be removed, and the proportions of MoS₂ and graphite are preferably based on the wet anti-friction varnish (2).

37. Component unit according to claim 36, wherein the proportion of polyimide resin is selected from a range with a lower limit of 65% and an upper limit of 75%, and the proportion des polyimide resin is preferably based on the polyimide resin together with solvent to be removed.

38. Component unit according to claim 36, wherein the proportion of polyimide resin is selected from a range with a lower limit of 67.5% and an upper limit of 72.5%, and the proportion of polyimide resin is preferably based on the polyimide resin together with solvent to be removed.

39. Component unit according to claim 36, wherein the proportion of polyimide resin is 70% and the proportion of polyimide resin is preferably based on the polyimide resin together with solvent to be removed.

40. Component unit according to claim 36, wherein the proportion of MoS₂ is selected from a range with a lower limit of 17% and an upper limit of 22%, preferably by reference to the wet anti-friction varnish (2).

41. Component unit according to claim 36, wherein the proportion of MOS₂is selected from a range with a lower limit of 18.5% and an upper limit of 21.5%, preferably by reference to the wet anti-friction varnish (2).

42. Component unit according to claim 36, wherein the proportion of MOS₂is 20%, preferably by reference to the wet anti-friction varnish (2).

43. Component unit according to claim 36, wherein the proportion of graphite is selected from a range with a lower limit of 7% and an upper limit of 13%, preferably by reference to the wet anti-friction varnish (2).

44. Component unit according to claim 36, wherein the proportion of graphite is selected from a range with a lower limit of 8.5% and an upper limit of 11.5%, preferably by reference to the wet anti-friction varnish (2).

45. Component unit according to claim 36, wherein the proportion of graphite is 10%, preferably by reference to the wet anti-friction varnish (2).

46. Component unit according to claim 1, wherein a ratio of MoS₂ to graphite is selected from a range with a lower limit of 1.5:1 and an upper limit of 4.5:1.

47. Component unit according to claim 1, wherein MoS₂ platelets with a mean length selected from a range with a lower limit of 10 μm and an upper limit of 40 μm and/or a mean width selected from a range with a lower limit of 10 μm and an upper limit of 40 μm and/or a mean height selected from a range with a lower limit of 2 nm and an upper limit of 20 nm are used.

48. Component unit according to claim 1, wherein MoS₂ platelets with a mean length selected from a range with a lower limit of 15 μm and an upper limit of 35 μm and/or a mean width selected from a range with a lower limit of 15 μm and an upper limit of 35 μm and/or a mean height selected from a range with a lower limit of 5 nm and an upper limit of 15 nm are used.

49. Component unit according to claim 1, wherein MoS₂ platelets with a mean length selected from a range with a lower limit of 18 μm and an upper limit of 25 μm and/or a mean width selected from a range with a lower limit of 18 μm and an upper limit of 25 μm and/or a mean height selected from a range with a lower limit of 5 nm and an upper limit of 8 nm are used.

50. Component unit according to claim 1, wherein graphite with a grain size selected from a range with a lower limit of 2 μm and an upper limit of 8 μm is used.

51. Component unit according to claim 1, wherein a surface of the anti-friction varnish (2) has an arithmetical mean roughness value Ra in accordance with DIN EN ISO 4287 selected from a range with a lower limit of 0.2 μm and an upper limit of 1.5 μm.

52. Component unit according to claim 1, wherein the surface of the anti-friction varnish (2) has an arithmetical mean roughness value Ra in accordance with DIN EN ISO 4287 selected from a range with a lower limit of 0.5 μm and an upper limit of 1.0 μm.

53. Component unit according to claim 1, wherein the surface of the anti-friction varnish (2) has an arithmetical mean roughness value Ra in accordance with DIN EN ISO 4287 selected from a range with a lower limit of 0.8 μm and an upper limit of 0.9 μm.

54. Component unit according to claim 1, wherein the surface of the anti-friction varnish (2) has a maximum roughness profile height Rz in accordance with DIN EN ISO 4287 selected from a range with a lower limit of 0.5 μm and an upper limit of 10 μm.

55. Component unit according to claim 1, wherein the surface of the anti-friction varnish (2) has a maximum roughness profile height Rz in accordance with DIN EN ISO 4287 selected from a range with a lower limit of 3 μm and an upper limit of 8 μm.

56. Component unit according to claim 1, wherein the surface of the anti-friction varnish (2) has a maximum roughness profile height Rz in accordance with DIN EN ISO 4287 selected from a range with a lower limit of 5 μm and an upper limit of 6 μm.

57. Method of producing a component (3, 14, 22), in particular a gear, a sprocket wheel, a chain wheel, a thrust washer, rotatably mounted parts which also effect only an oscillating movement and are subjected to an axial and/or radial load, a coupling, such as a coupling body, parts of claw couplings, a sliding sleeve, a synchronizer ring, a sintered housing, a thrust or radial bearing, a rotor or stator in VVT systems, made from a powder or powder mixture containing metallic and optionally non-metallic components produced by compressing this powder or powder mixture, followed by sintering, wherein an anti-friction varnish (2) according to claim 13 is applied to at least one surface portion (13, 13, 20) of the component (3, 14, 22) after sintering, in particular by spraying or painting.

58. Method of producing co-operating surface portions (12, 13, 20) of components (3, 14, 22) of a component unit, at least one of which components (3, 14, 22) is made from a powder or powder mixture containing metallic and optionally non-metallic components produced by compressing this powder or powder mixture, followed by sintering, and whereby the two surface portions (12, 13, 20) are manufactured within pre-definable tolerance ranges with respect to one another, according to claim 57, wherein an anti-friction varnish (2) is applied to at least one of the two surface portions (12, 13, 20) of whichever component (3, 14, 22) is made from the powder or powder mixture in a coating thickness which corresponds at least to the gap dimension pre-definable by means of the tolerances ranges, after which the components (3, 14, 22) are moved into their predefined position relative to one another and the two surface portions (12, 13, 20) are moved relative to one another until the two surface portions (12, 13, 20) are moved into a virtually gap-free abutting contact with one another.

59. Method according to claim 58, wherein the virtually gap-free abutting contact of the two surface portions (12, 13, 20) with one another is obtained by means of a relative shift of elements of the anti-friction varnish (2) effected with respect to at least one surface portion (12, 13, 20).

60. Method according to claim 58, wherein the virtually gap-free abutting contact of the two co-operating surface portions (12, 13, 20) with one another is obtained by removing elements from at least certain regions of the anti-friction varnish (2) on at least one of the surface portions (12, 13, 20).

61. Method according to claim 58, wherein the virtually gap-free abutting contact is established continuously across the mutually facing surface portions (12, 13, 20).

62. Method according to claim 58, wherein both of the co-operating components (3, 14, 22) area made from the powder or powder mixture.

63. Method according to that claim 58, wherein both of the surface portions (12, 13, 20) of the components (3, 14, 22) are coated with the anti-friction varnish (2).

64. Use of an anti-friction varnish for coating gears, sprocket wheels, chain wheels, thrust washers, rotatably mounted parts which also effect only an oscillating movement and are exposed to an axial and/or radial load, couplings such as coupling bodies, parts of claw couplings, sliding sleeves, synchronizer rings, sintered housings, thrust or radial bearings, rotors or stators in VVT systems.
